(19) United States
(12) Patent Application Publication
(10) Pub. No.: US 2024/0127211 A1
(43) Pub. Date: Apr. 18, 2024

(54) Systems and Methods for Distributing, Purchasing, Owning, and Playing Video On Demand and Distributing Royalties

(71) Applicant: MOVIEKEY USA LLC, Lewes, DE (US)

(72) Inventor: Alexander Asher Newton, London (GB)

(73) Assignee: MOVIEKEY USA LLC, Lewes, DE (US)

(21) Appl. No.: 18/317,779

(22) Filed: May 15, 2023

Related U.S. Application Data
(60) Provisional application No. 63/364,627, filed on May 13, 2022.

(51) Int. Cl. G06Q 20/12; G06F 21/10; G06Q 20/36; G06Q 30/0645

(52) U.S. Cl. CPC G06Q 20/1235; G06F 21/101; G06Q 20/3674; G06Q 30/0645; G06Q 2220/10

(57) ABSTRACT

Systems for creating and distributing digital rights management (DRM)-unlocking non-fungible tokens (NFTs) associated with DRM-encrypted video content. One embodiment system enables users to purchase, own, and access video content through the ownership of DRM-unlocking NFTs. Many embodiments include the steps of generating a DRM-unlocking NFT smart contract, uploading the encrypted video content, setting NFT parameters, and providing instant payment to the distributor's wallet address via blockchain upon NFT purchase. Embodiments also allows for the integration of hybrid DRM-unlocking NFTs that grant access to both physical events and video-on-demand content, as well as facilitating rental management, transfers, and temporary content sharing. Other examples of the inventive subject matter enable the creation of farmable DRM-unlocking NFTs, allowing users to own and access farmable NFTs and the content they generate. Many of the embodiments are adaptable and can be integrated with various video-on-demand and physical event platforms.

### CROSS-REFERENCES TO RELATED PATENT APPLICATIONS

This application claims the benefit of U.S. Provisional Application No. 63/364,627, filed on May 13, 2022, the entire content of which is incorporated herein by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND

### Field of the Inventive Subject Matter

The present inventive subject matter relates to systems and methods for purchasing, owning, distributing, and viewing video on demand (VOD), accessible with blockchain-based tokens.

### Background

In traditional video-on-demand (VOD) systems, customers purchase access to movies, television shows, and other premium video content on platforms that operate as walled gardens. These platforms often charge prices for digital content comparable to physical copies, such as DVDs or Blu-ray discs. However, unlike physical copies, the digital content purchased on these platforms does not permit resale or true ownership. Instead, customers acquire a license to view the premium video within the confines of the platform. This form of premium video differs from streaming services that resemble premium cable services, providing content on a predetermined, all-you-can-binge basis. Conventional premium video offerings involve platforms advertising content for users to “buy” or “rent” specifically on their platform. These legacy VOD systems maintain full control over the premium content they sell and distribute, limiting customers' ownership and flexibility in accessing their purchased content.

The present inventive subject matter addresses the limitations of traditional VOD systems by introducing a novel approach that leverages blockchain technology and non-fungible tokens (NFTs) to provide users with true ownership, enhanced flexibility, and the ability to resell or trade their purchased content. This updated VOD system empowers users by granting them control over their digital content collections, while offering additional features such as rentals, physical event access, and integration with various applications through an SDK and API.

### SUMMARY

The present inventive subject matter provides computer-implemented systems and methods utilizing a blockchain-based token standard called a DRM-unlocking non-fungible token (NFT). The DRM-unlocking NFT enables true ownership of digital video-on-demand files that are accessible only to the NFT owner, including, but not limited to, movies, television specials, episodes, seasons, documentaries, and events. Embodiments also include the ability for owners of premium versions of DRM-unlocking NFTs to “farm” standard DRM-unlocking NFTs, creating a scalable digital movie store business with pricing built into the smart contract. Many embvodiments allow for the establishment of a standard for securely accessing video-on-demand content across various blockchain-compatible applications, such as virtual worlds, decentralized social networks, and other platforms built with web3 technology.

Embodiments of the inventive subject matter also include systems and methods to streamline royalty payments to intellectual property (IP) owners and other royalty recipients, such as affiliate sellers or distributors. Many of the embodiments provide distributors with the ability to distribute premium VOD content to audiences and exhibitors from a single platform. Additionally, the DRM-unlocking NFT enables access to exhibitors' physical locations, offering a comprehensive distribution platform for IP holders, cinemas, and filmmakers to reach their audiences. This allows audiences to truly own their digital movies and enjoy more experiences with premium film and video content.

One embodiment is a system for creating and distributing DRM-unlocking non-fungible tokens (NFTs) associated with DRM-encrypted video content for allowing users to purchase and own access to the content, including:
a. a DRM-unlocking NFT platform for playing encrypted content;
b. an interface for allowing one or more distributors to deploy one or more DRM-unlocking NFT smart contracts and set one or more DRM-unlocking NFT price and parameters related to the encrypted content including one or more of the following parameters: availability, launch date, rental conditions, NFT farming access, physical event access, and rewards;
c. a server configured to store encrypted content and associate it with one or more DRM-unlocking NFT smart contracts and one or more NFTs;
d. a platform database that stores the encrypted content and parameters about the one or more DRM-unlocking NFTs, including one or more of the following parameters: metadata with a unique identifier, artwork, and a video player link;
e. a payment system that provides instant payment to one or more distributors' wallet addresses via a blockchain when one or more DRM-unlocking NFTs are purchased;
f. a verification system that connects a user's wallet to the DRM-unlocking NFT platform for verifying the user's ownership of the DRM-unlocking NFT associated with the encrypted content; and
g. a delivery system that grants a DRM-unlocking NFT owner access to the encrypted content by sending one or more DRM licenses to the DRM-unlocking NFT owner's device along with the encrypted content so that the DRM-unlocking NFT owner can play the decrypted content on the DRM-unlocking NFT platform or on one or more third-party platforms that request and receive the DRM license information from the DRM-unlocking NFT platform.

Another embodiment further includes a feature allowing the one or more distributors to send one or more payments to one or more blockchain wallet addresses.

Another embodiment further includes a rental manager that enables one or more DRM-unlocking NFT owners to rent the encrypted content associated with the one or more DRM-unlocking NFTs content to others according to the one or more predetermined parameters.

Another embodiment allows distributors and physical exhibitors to create one or more hybrid DRM-unlocking NFTs that allow access to both physical events and encrypted content.

Another embodiment allows one or more hybrid DRM-unlocking NFTs to have metadata relating to information on the physical event location, the time of the physical event, the seat selection for the physical event, and the distributor's agreement with the exhibitor for access to the encrypted content.

Another embodiment further includes an authenticator authenticating the ownership of the one or more hybrid DRM-unlocking NFTs for allowing access to the physical event access by scanning a QR code, sharing their location with the ticket gate, or logging into a decentralized application.

Another embodiment further includes one or more application players for DRM-unlocking NFT owners to access and play DRM-encrypted content in any application player that has implemented the related SDK and API, wherein the application player enables DRM-unlocking NFT owners to:
a. select the DRM-unlocking NFT associated with the desired content; and
b. play the encrypted content within the one or more application players having the SDK and API integrated with the application player.

Another embodiment further includes a system for allowing DRM-unlocking NFT owners to transfer, sell, or trade DRM-unlocking NFTs on the DRM-unlocking NFT platform or one or more third-party marketplaces.

Another embodiment further includes a virtual gallery for enabling DRM-unlocking NFT owners to showcase their DRM-unlocking NFT collection and encrypted content in a virtual gallery.

Another embodiment further includes a sharing module for enabling one or more DRM-unlocking NFT owners to provide limited access to the encrypted content with one or more third party users based on one or more parameters by providing:
a. a selection mechanism for the DRM-unlocking NFT associated with the encrypted video content to be shared;
b. a sharing interface;
c. one or more adjustable sharing parameters selected from one or more of the following: duration of access and one or more access limitations;
d. a unique sharing link or a code for the selected encrypted content; and
e. a communication mechanism for sending the sharing link or code to one of more third party users, allowing one or more of those users to access the encrypted content within the specified parameters.

Another embodiment further includes a farming module configured to allow distributors to offer NFT farming access as part of the DRM-unlocking NFT parameters, by:
a. creating a farming-enabled DRM-unlocking NFT represented by a smart contract;
b. setting one or more farming parameters from which the farming-enabled DRM-unlocking NFTs can be farmed; and
c. enabling one or more DRM-unlocking NFT owners to farm one or more farming-enabled DRM-unlocking NFTs.

Another embodiment further includes a reward module configured to allow distributors to offer rewards as part of the DRM-unlocking NFT parameters by:
a. creating a reward-enabled DRM-unlocking NFT represented by a smart contract;
b. setting the one or more reward parameters selected from one or more of the following: one or more reward amounts and one or more eligibility criteria; and
c. enabling DRM-unlocking NFT owners to access and claim one or more rewards according to the one or more reward parameters.

Another embodiment further includes a SDK and an API provider module configured to enable the encrypted content to be playable in any application that has implemented the SDK and the API, by:
a. allowing developers to integrate the platform's DRM-unlocking NFT functionality within one or more third party applications;
b. providing a set of tools and documentation for developers to customize the user interface and user experience within the one or more third party applications;
c. facilitating the secure exchange of data between the DRM-unlocking NFT platform and the one or more third party applications, ensuring the DRM-unlocking NFT ownership verification and DRM license delivery processes are verified;
d. enabling developers to access and display DRM-unlocking NFT metadata within the one or more third party applications, allowing users to view information about the video content, such as title, description, artwork, and unique identifier; and
e. enabling developers to add a play button to the one or more third party applications allowing users to play the encrypted video content within the one or more third party applications.

Another embodiment further includes a content access module configured to enable one or more DRM-unlocking NFT owners to access one or more additional features and/or encrypted content within the DRM-unlocking NFT platform, based on the one or more predetermined parameters by:
a. verifying ownership of the DRM-unlocking NFT and checking the one or more predetermined parameters; and
b. granting access to the one or more features or content within the platform, such as exclusive behind-the-scenes footage, director's commentary, or bonus materials, based on the one or more predetermined parameters.

In many embodiments, the encrypted content is one or more encrypted videos.

Another embodiment further includes a remind me later module feature configured to enable one or more users to set reminders to watch, purchase, or rent content at a later date through various communication channels, including email, text message, phone call, or social media direct message.

Another embodiment further includes a distribution analytics module configured to provide one or more distributors with insights into the performance of their content, by tracking and reporting metrics such as total views, sales, rentals, and “remind me later” requests for each piece of content.

Other embodiments include a system for creating, distributing DRM-unlocking non-fungible tokens (NFTs) associated with DRM-encrypted video content and allowing users to purchase and own access to the DRM-encrypted video content, including:
a. a DRM-unlocking NFT platform serving as a central platform for playing content;
b. an interface that allows distributors to deploy one or more DRM-unlocking NFT smart contracts, an associated DRM-unlocking NFT price, and one or more parameters selected from the following: availability, launch date, rental conditions, NFT farming access, physical event access, and rewards;
c. a server configured to store encrypted video content and associate it with the one or more DRM-unlocking NFT smart contracts and one or more NFTs;
d. a platform database that stores the encrypted video content and information about the DRM-unlocking NFT, including one or more of the following: metadata with a unique identifier, artwork, and a video player link;
e. a payment system that provides payment to one or more wallet addresses via blockchain when one or more DRM-unlocking NFTs are purchased;
f. a verification system for linking the one or more wallet addressed to the DRM-unlocking NFT platform and for verifying ownership of the DRM-unlocking NFT linked to the encrypted video content;
g. a delivery system for granting the DRM-unlocking NFT owner access to the encrypted video content by sending a DRM license and the encrypted video file to the DRM-unlocking NFT owner's device so that the decrypted video can be played on the central platform or one or more third-party platforms that calls the central platform to send the DRM license;
h. a management system for allowing payments to be sent when a DRM-unlocking NFT is purchased; and
i. a partnership management system for allowing one or more distributors and one or more exhibitors the ability to co-create hybrid DRM-unlocking NFT smart contracts that mint one or more NFTs capable of allowing owners entry to physical events and downloading and decrypting the DRM-encrypted VOD files associated with the DRM-unlocking NFT smart contract and its associated one or more NFTs.

Another embodiment is a method for creating and distributing DRM-unlocking non-fungible tokens (NFTs) associated with DRM-encrypted video content, allowing users to purchase and own access to the DRM-encrypted video content, comprising:
a. generating a DRM-unlocking NFT smart contract using a DRM-unlocking NFT platform;
b. uploading the DRM-encrypted video to a server and associating it with the DRM-unlocking NFT smart contract in a DRM-unlocking NFT platform database;
c. offering an interface for distributors to set DRM-unlocking NFT price and one or more parameters selected from the following: availability, launch date, rental conditions, NFT farming access, physical event access, and rewards;
d. adding metadata to the DRM-unlocking NFT selected from one or more of the following: a unique identifier, artwork, and a video player link;
e. making the DRM-unlocking NFT available for users to purchase;
f. providing instant payment to one or more distributors' wallet addresses via a blockchain when one or more DRM-unlocking NFTs are purchased;
g. verifying a user's ownership of the DRM-unlocking NFT linked to the encrypted video content by connecting the user's wallet to the platform; and
h. granting access to the encrypted video content by sending a DRM license to the user's device after verifying the user's DRM-unlocking NFT ownership.

The method of claim 19, further comprising the steps of:
a. providing a platform for distributors and physical exhibitors to collaborate and create a hybrid DRM-unlocking NFT;
b. creating the hybrid DRM-unlocking NFT with metadata including one or more of the following attributes: a physical event location, a time, seat selection, and the distributor's agreement with the exhibitor for digital VOD file access; and
c. authenticating the ownership of the hybrid DRM-unlocking NFT for physical event access by doing one or more of the following: verifying a code, sharing their location with the ticket gate, or logging into a decentralized application;

wherein distributors and physical exhibitors can utilize one or more hybrid DRM-unlocking NFTs for providing access to physical events and video-on-demand (VOD) content.

Another embodiment of the method further includes enabling DRM-unlocking NFT owners to access additional features or content within the platform, based on the distributor-set parameters, comprising:
a. verifying the user's ownership of the DRM-unlocking NFT and checking the associated parameters of the DRM-unlocking NFT; and
b. granting access to one or more features or encrypted content within the DRM-unlocking NFT platform with the one or more features selected from the following: exclusive behind-the-scenes footage and director's commentary.

Another embodiment of the method further includes the steps of enabling DRM-unlocking NFT owners to showcase their DRM-unlocking NFT collection and video content in a virtual gallery, comprising:
a. accessing the virtual gallery feature within the platform;
b. selecting the DRM-unlocking NFTs and associated video content to be displayed;
c. customizing the virtual gallery's layout, design, and user experience; and
d. sharing the virtual gallery with other users or embedding it on one or more external websites or platforms.

Another embodiment of the method further includes the steps of allowing distributors to offer NFT farming access as part of the DRM-unlocking NFT parameters, comprising:
a. creating a farming-enabled DRM-unlocking NFT represented by a smart contract;
b. setting the farming parameters from one or more of the following: a collection from which the DRM-unlocking NFTs can be farmed and a farming rate; and
c. enabling one or more DRM-unlocking NFT owners to farm new DRM-unlocking NFTs according to the farming parameters.

### BRIEF DESCRIPTION OF THE DRAWINGS

FIG. 1 illustrates a hybrid DRM-unlocking NFT event management application, referred to as “CinemaFriend,” in accordance with embodiments of the inventive subject matter;

FIG. 2 illustrates a DRM-unlocking NFT collection, referred to as “MOVIEKEY,” displayed in the owner's digital movie cabinet according to embodiments of the inventive subject matter;

FIG. 3 illustrates a digital movie cabinet mobile application, referred to as “MOVIEKEY Cabinet,” according to embodiments of the inventive subject matter;

FIG. 4 illustrates a high-level view of infrastructure processes in a DRM-unlocking NFT system, in accordance with embodiments of the inventive subject matter;

FIG. 5 illustrates a premium DRM-unlocking NFT, referred to as “MOVIEKEY+,” enabling the owner to farm standard MOVIEKEYs at a fixed price according to embodiments of the inventive subject matter;

FIG. 6 illustrates a DRM-unlocking NFT owner's device connected to a virtual world decentralized app via the owner's NFT wallet, in accordance with embodiments of the inventive subject matter;

FIG. 7 illustrates a DRM-unlocking NFT owner's device connected to a virtual world decentralized app via the owner's NFT wallet, in accordance with embodiments of the inventive subject matter;

FIG. 8 illustrates a DRM-unlocking NFT smart contract creator, referred to as “MOVIEKEY Smart Contract Creator,” according to embodiments of the inventive subject matter;

FIG. 9 illustrates a DRM-unlocking NFT smart contract manager, referred to as “MOVIEKEY Smart Contract Manager,” according to embodiments of the inventive subject matter;

FIG. 10 illustrates a digital movie cabinet desktop application, referred to as “MOVIEKEY+ Cabinet,” according to embodiments of the inventive subject matter;

FIG. 11 illustrates a DRM-unlocking NFT usage chart, referred to as “MOVIEKEY Play Chart,” according to embodiments of the inventive subject matter;

FIG. 12 illustrates a QR code interaction for the digital cinema application “CinemaFriend,” according to embodiments of the inventive subject matter;

FIG. 13 illustrates a content sharing application, referred to as “SEND TO TV,” according to embodiments of the inventive subject matter; and

FIG. 14 illustrates a DRM-unlocking NFT system, referred to as “MOVIEKEY,” as used with a third-party application according to embodiments of the inventive subject matter.

### DETAILED DESCRIPTION

According to embodiments of the claimed subject matter, various systems and methods for purchasing, owning, distributing, and viewing video-on-demand (VOD) content that are accessible with one or more blockchain-based tokens are disclosed.

In many embodiments, the customer takes custody of the content in the form of a DRM-unlocking non-fungible token (NFT), referred to in the provisional patent as “MOVIEKEY,” which is verified by a unique smart contract that can contain new additions or conditions compared to previous types of smart contracts.

In these embodiments, the DRM-unlocking NFT can be purchased via a credit card or another payment method, such as using a cryptocurrency for payment. The DRM-unlocking NFT may also be swapped for other DRM-unlocking NFTs or even any other type of non-fungible tokens (NFTs) that respective owners would agree to use for a trade. A “non-fungible token” refers to a type of digital asset. Any NFT may include its own unique information, attributes, or characteristics. An NFT may comprise permanent, unalterable metadata that describes or defines its authenticity and is transferable in terms of ownership between nodes of the decentralized network. In these embodiments, a customer may be a movie collector who has amassed a $5,000 worth of Blu-Rays and decides to liquidate their collection at a physical electronics exchange for store credit or a marketplace (online or physical) for cash to buy something else. They can do this because they own physical products. A customer who has purchased a license to watch video-on-demand files on a traditional VOD website or application cannot resell the files outside of the walled garden. DRM-unlocking NFT enables customers to resell their VOD collection on any NFT marketplace, some of which are decentralized, while others are centralized. The Internet of Things (IoT) attempts to combine the offline and online/digital worlds with the use of smart devices and sensors, which can function in a wide variety of ways. For instance, embodiments can be used to predict events and manage environments leading to greater efficiency that could save vast amounts of money in many industries.

In accordance with an exemplary implementation of the inventive subject matter, a method is provided to utilize a DRM-unlocking NFT, a digital token that exists as a product of a smart contract on a blockchain. It can be a non-fungible item (such as wherein every DRM-unlocking NFT in that unique smart contract is also unique in some way, like using individual artwork or traits of artwork) or it can be semi-fungible (where every DRM-unlocking NFT in that unique smart contract appears the same but is unique from other DRM-unlocking NFTs from other unique smart contracts). In these embodiments, a DRM-unlocking NFT can also be viewed in a compatible cryptocurrency wallet alongside one or more NFTs.

In many embodiments, the VOD file has a unique DRM-unlocking NFT or an enhanced version of the DRM-unlocking NFT (e.g. MOVIEKEY+) token that includes a smart contract. Some VOD files may only have a single DRM-unlocking NFT token, but more than one token may also be used. A VOD file may have more than one DRM-unlocking NFT token. In these embodiments, distributors can control their DRM-unlocking NFT smart contracts with their blockchain wallets and through a visual interface on a suitable platform such as a website or app-based platform.

The DRM-unlocking NFT smart contract allows video distributors to set a minimum price on customer-to-customer secondary marketplace sales so that secondary sales do not undercut direct sales of DRM-unlocking NFT tokens from distributor to customer. In one embodiment, a distributor selects the inclusion of the option to use a minimum secondary market sale price.

In this way, a customer may buy a DRM-unlocking NFT token for $20 but may not sell it for less unless the distributor allows it via the initiation of a function in the smart contract the distributor controls. Initiation of the function on the interface will open a signature request for the distributor to sign the parameter change request onto the blockchain. For example, the distributor can change the secondary marketplace minimum sale price from $20 to $15. In this embodiment, inputting the data into the application and clicking the confirm button will open a wallet transaction request. Signing the request will update the smart contract rules, and the resulting new minimum price at which resellers can resell the DRM-unlocking NFT token for will be $15.

In these embodiments, using a platform interface, the distributor is able to set parameters, such as secondary market prices, and update them as desired. Distributors can also input royalty recipients (represented by blockchain wallet addresses) into the smart contract. In this way, distributors can receive a royalty payment after a sale of a DRM-unlocking NFT token or after a certain number of DRM-unlocking NFT token sales have taken place. Distributors can update royalty parameters and secondary market sale minimum prices by signing the request on the blockchain through the distribution platform application after the contract is deployed.

In many embodiments, enhanced DRM-unlocking NFT owners have special access to purchase standard DRM-unlocking NFT tokens associated with the premium video/film, and the particular enchanted DRM-unlocking NFT they own (or have rights in) represents a value at a wholesale price. For example, the wholesale price of an exemplary token might be $10, and the secondary market price the distributor has selected for that same token might be $20.

The distributor can set any number of parameters for any given pair of enhanced DRM-unlocking NFT and DRM-unlocking NFT smart contracts, with those parameters representing rights over a single VOD file. In these embodiments, the enhanced DRM-unlocking NFT owner (who can now sell the VOD title as a digital retailer of VOD) will only be able to sell the paired DRM-unlocking NFT for $20 or more.

In some embodiments, the distributor may allow the digital retailer to sell a token for less than a stated value by initiating a smart contract call through the distribution platform. The retailer may also use the platform to request that the distributor lower the price of a token. Many embodiments also allow for a group of enhanced DRM-unlocking NFT owners to vote along with the distributor for price control. For example, the distributor's vote may weigh 50% on the smart contract, and the enhanced DRM-unlocking NFT owners may collectively have 50% voting power over the smart contract. If a retailer requests a minimum price reduction, all retailers and the distributor can vote to accept or reject that specific price reduction. If the reduction is accepted by a majority vote, the minimum price will change. If the reduction is rejected, the price will not change. The embodiments enable streamlined collaboration between retailers and distributors. In some embodiments, distributors can input an order when deploying the DRM-unlocking NFT and enhanced DRM-unlocking NFT smart contracts into the platform so that the distributor has full control over secondary market pricing and that the retailers (enhanced DRM-unlocking NFT owners in these embodiments) have no vote or ability to control the secondary market pricing of the specified token.

In many of the embodiments, customers may purchase physical-digital (phygital) DRM-unlocking NFT tokens. In some embodiments, a customer buys the digital DRM-unlocking NFT token and is given an option to upgrade the digital token so that they receive a physical disc in the mail or via another means such as a courier. In some embodiments, should a recipient agree to sell the digital DRM-unlocking NFT token on a secondary market, the recipient may also be required to send the physical counterpart of the digital DRM-unlocking NFT token to the new owner of the transferred token, should the new owner request the physical item.

In these embodiments, the application marketplace provides a simple route to enable customers and resellers to streamline secondary sale transactions of phygital items. In one exemplary process, the seller first lists the DRM-unlocking NFT and uploads a picture of the physical counterpart of the digital DRM-unlocking NFT token in which they own rights. When a new owner purchases the phygital DRM-unlocking NFT from the reseller, the new owner immediately receives the digital DRM-unlocking NFT. The reseller is then given an address by the buyer or the marketplace so that the physical disc can be sent to the buyer. The physical disc is connected to the digital DRM-unlocking NFT token, and the physical disc is traceable to the digital DRM-unlocking NFT token. If the physical disc were offered for sale separately, the buyer would be able to see on the platform that the disc sale should also include the digital DRM-unlocking NFT token.

Some embodiments employ a DRM-unlocking NFT player, which can enable a series of events that allow the video content to be viewed by the owner of a specific DRM-unlocking NFT. In numerous embodiments, DRM-unlocking NFT distributors have the option to permit owners of their DRM-unlocking NFTs to invite friends to watch in an online viewing session. The distributor can limit the number of viewers in the viewing session to any predetermined number. The distributor can also enable DRM-unlocking NFT owners to host wider community screenings of the content associated with the DRM-unlocking NFT they own via the platform. In these embodiments, the owner of the DRM-unlocking NFT can be given the option by the distributor to sell digital tickets for a single digital screening of the video content as another NFT. In some of these embodiments, the distributor dictates the community screening host's profit cut from this by inputting that data into the platform interface so that the terms are written into the smart contract that controls these interactions.

In many of these embodiments, every piece of video content (for example, a movie, TV show, or other premium video such as a documentary, sporting event, or concert film) has its own DRM-unlocking NFT smart contract and enhanced DRM-unlocking NFT smart contract. These contracts generate individual NFTs that represent ownership over a copy of that video content. This ownership goes beyond a mere license to view; it includes the right to trade, resell, and share a video as a digital emulation of a physical disc. The encrypted content can be stored on one or more centralized platform servers or downloaded onto the user's device, while the DRM license to decrypt the encrypted content is sent via one or more centralized platform servers.

In many embodiments, the encrypted content can be stored on a decentralized storage system, providing an alternative to centralized servers. Despite using decentralized storage for the content, the DRM license required to decrypt the encrypted video would still be sent through a centralized platform. This approach includes primary features like DRM-unlocking NFTs and allows for the integration of optional unique features, such as farming, rewards, reminders, analytics, exclusive content, and rentals, while leveraging decentralized storage solutions. By integrating a centralized platform for DRM license distribution and management, secure and controlled access to the encrypted content can be ensured, and important parameters relating to DRM access can be easily updatable.

The DRM-unlocking NFT player (which can be web-based or native to a device) is accessed by the owner/collector of a DRM-unlocking NFT. In some embodiments, DRM-unlocking NFT owners may access the player by opening the DRM-unlocking NFT application and connecting their NFT wallet to the application. The application then reads the contents of their NFT wallet and displays one or more DRM-unlocking NFTs the wallet owner owns. The player will display those DRM-unlocking NFTs visually or in any other suitable manner. For visually impaired users, an audio presentation may be utilized. In each of these embodiments, the owner of the DRM-unlocking NFT is presented with one or more available options. In some embodiments, the owner of a DRM-unlocking NFT can stream the associated video file in the application or to an external video display via the use of a QR code on a TV application, so that the video is sent to that display. For example, when the owner of a DRM-unlocking NFT selects a file to play that is associated with that particular DRM-unlocking NFT, the player relays a call to the DRM license provider that will send a license to the device the owner is using, so that the encrypted video file can be decrypted for a specified period.

In cases where the ownership of the DRM-unlocking NFT has been changed and the prior owner no longer owns any rights to the DRM-unlocking NFT, that previous owner will no longer have the ability to see that particular DRM-unlocking NFT in the collection found in the player. They also may not receive any new DRM licenses to decrypt the encrypted video. Thus, the video will not be able to be played even if the video is downloaded or stored on their device without the DRM-unlocking NFT.

In several embodiments, the video associated with the DRM-unlocking NFT can also be played in any other application that has implemented the SDK (software developer kit) and API (application programming interface) provided by the DRM-unlocking NFT player platform. In these embodiments, a play button may be added in another application such as a social platform, a metaverse platform, VR, or AR world so that the content can be played. The owner of the DRM-unlocking NFT will be able to see their DRM-unlocking NFT collection everywhere that allows the connection of an NFT wallet. In many of these embodiments, the metadata of the DRM-unlocking NFT includes a link to the player that will allow the owner of the DRM-unlocking NFT to initiate a process to play the video associated with that DRM-unlocking NFT from any site or application that allows an NFT wallet connection and a display of the NFTs contained in the wallet.

In some embodiments, a third-party platform can use the DRM-unlocking NFT SDK and API to enable the video content to be accessed and played in that platform when permission is granted based on the rights in the associated DRM-unlocking NFT. In other embodiments, the video content may be linked out to a third-party application that may play the DRM-unlocking content on a third-party platform or device. In these embodiments, the playing of the content would be implemented according to the rights stored in the DRM-unlocking NFT.

In some exemplary embodiments, a DRM-unlocking NFT platform serves as the central platform for playing content. In other embodiments, a virtual world can use the DRM-unlocking NFT SDK and API to enable the DRM-unlocking NFT player to exist in their platform so authenticated content can be played in that platform. In many of the embodiments, the verification and device authorization processes along with the license to play the content are sent or relayed by the DRM-unlocking NFT platform to the player device. In other embodiments, instead of the call starting on the central platform, the call starts on a third-party platform that calls the central platform to send the DRM license to the player. For example, the initiator of the call from a third-party application would be the owner of the DRM-unlocking NFT, and the initiator could interact with the interface that has been built by the third party using the DRM-unlocking NFT SDK and API, for example, using a DRM-unlocking NFT SDK provided standard button that would initiate and allow fulfillment of the process. In many of these embodiments, the button can be customized to fit the visual aesthetic of the third-party application. The player can also be customized to fit the aesthetic of the third-party application.

In many of the embodiments, the DRM-unlocking NFT platform allows DRM-unlocking NFT owners to offer their content for rent by wrapping the DRM-unlocking NFT in a new token that reverts to the owner renting it out after a selected period of time or after one or more predetermined events, such as the play of the title on a display. In some embodiments, the “rental” token may remain in the renter's wallet as a memento of the rental but will not allow access to view the VOD after the agreed rental period has expired. In some embodiments, the distributor can dictate how the DRM-unlocking NFT owners are allowed to rent to renters from the DRM-unlocking NFT platform. For example, the owner of the DRM-unlocking NFT can specify how many days they are willing to rent the content in the DRM-unlocking NFT platform interface. In many of the embodiments, the parameters of each rental may be limited or defined by the distributor of the DRM-unlocking NFT. For instance, an owner may be allowed by the distributor to rent content associated with a DRM-unlocking NFT for a specified period of time, such as one day or two days. In these embodiments, if the distributor has ordered the smart contract to only allow one day of rentals, the owner of the DRM-unlocking NFT may only rent the content out for one day.

In many of the described embodiments, the owner of an enhanced DRM-unlocking NFT sees the option on a digital movie cabinet located on the DRM-unlocking NFT platform so that they can acquire additional DRM-unlocking NFTs for that VOD, as long as they are verified as the owner of the associated enhanced DRM-unlocking NFT with ownership rights verified by the blockchain that interacts with the DRM-unlocking NFT platform. In these embodiments, the user selects the number of DRM-unlocking NFTs they would like to purchase at the wholesale price. They pay for it either with their credit card or with cryptocurrency, and the DRM-unlocking NFTs they purchase are delivered directly to their wallet.

Many of the embodiments include a DRM-unlocking NFT creation interface flow for distributors. In these embodiments, when a distributor creates a DRM-unlocking NFT smart contract on the platform, they have the option to work with third parties to interact with the DRM-unlocking NFT platform and/or the DRM-unlocking NFTs. In one embodiment used with theatrical releases, a distributor can allow exhibitors to accept a DRM-unlocking NFT smart contract's tokens for ticketing to physical viewings of the movie the DRM-unlocking NFT represents. In some embodiments, distributors can allow intellectual property rights to be sold for various rights, including but not limited to ancillary streaming and terrestrial programming These rights can also include derivative works such as merchandise associated with the content, such as brands, names, and likenesses. Payments for such rights can be paid to them in a fiat or a crypto-based currency or a combination of both and paid out in any form, such as a crypto payment directly to one or more IP stakeholders.

In some embodiments, a CinemaFriend application is used to enhance experiences for DRM-unlocking NFTs with physical experiences. In these embodiments, the CinemaFriend application enables physical exhibitors, for example, theater owners, distributors, and/or IP rights holders, to combine physical screening tickets, access to VOD with revenue share automation, and the enablement of customers to access physical screenings and events if they own a DRM-unlocking NFT or another smart contract access token.

In these embodiments, the prices of both the physical screening ticket and standard digital DRM-unlocking NFT can be combined into a variation of the DRM-unlocking NFT that would be valued at a premium. For example, the cost of a cinema ticket for Film X is $20, and the cost of a standard DRM-unlocking NFT for Film X is $20—a premium DRM-unlocking NFT smart contract can combine both products into one hybrid physical screening and VOD access DRM-unlocking NFT priced in this example at $40. Owners of the hybrid physical screening and VOD access DRM-unlocking NFT that smart contract governs would have access to a panel in a platform application where they can select a location, time, and seat for a physical screening, and depending on the distributor's agreement with the exhibitor, they will also have access to view the digital VOD file day-and-date or after a specific amount of time that the distributor has written into the smart contract via the distribution platform interface. For example, the digital file may be available simultaneously with the physical screening. Alternatively, it may become available hours, days, weeks, or months after, depending on what the distributor/IP rights owner has decided. In the example of Film X: the revenue split would be even: $20 to the distributor and $20 to the exhibitor. However, the split can be any amount as exhibitors and distributors can communicate and agree on deals through the interface of the application. Whatever the split agreement, both the distributor/IP rights holder and the exhibitor will both, in effect, write the parameters into the smart contract with signature requests. Alternatively, either one can be the sole manager of the smart contract, or they can nominate the platform to take custody of the smart contract as a service. Suppose they nominate the platform to take custody of the smart contract. In that case, they will provide their blockchain wallet addresses or bank details for payments. In the distribution platform interface, they will agree on their deals/revenue share and submit the deal information to the platform to write onto the blockchain on their behalf.

In many embodiments, for the customer to access a specific physical event location at a specific time for a specific event, they will authenticate their ownership of the DRM-unlocking NFT. This process can enable access to any physical event with a DRM-unlocking NFT or another type of smart contract token or NFT that the exhibitor/venue has predetermined as enabling access through the platform's event management interface.

For an access token owner/customer to access an event, the customer must be logged in on their mobile device or another smart device either to the platform (that has already authenticated their ownership over the DRM-unlocking NFT or other access token, by connecting their token wallet to the platform) or the customer must have their token wallet installed on their mobile device, or another smart device, and have their mobile device or another smart device with them at the venue, and use it to interact with a human employee's device that is running an enterprise application, or an electronic ticket gate.

In some embodiments, the customer has logged in with their mobile device or another smart device to the platform (either web app or native) and thus has already authenticated their ownership over the DRM-unlocking NFT or access token allowing the customer multiple ways to access the event.

In many of the embodiments, access to an event can be granted through various methods. For example, at the venue, there can be a non-human ticket gate, a human, or a human-like robot with a verification device that allows access to the event after token ownership verification. The customer will be able to authenticate token ownership and access the venue and event using a code, for example by scanning a QR code, numerical code, barcode, or any other unique visual identifier readable by the customers device displayed on a screen on the ticket gate via the platform application on their mobile device or by sharing their location with the ticket gate via a setting in the platform application. The application server sends an approval order to the venue ticket gate after confirming token ownership. Once the ticket gate receives the approval order, the gate opens. If the customer chooses to share their location with the ticket gate, the platform application will send a server order to the ticket gate to let the access token owner into the venue once the access token owner is at the gate.

In some embodiments, customers may choose to use their token wallet for authentication. In these cases, the authentication will happen as a signature request on-chain, beginning with a wallet connection approval, essentially logging them into a decentralized application that can control the ticket gate. Upon authentication, the ticket gate will open if access is granted. If access is not granted, the ticket gate will give a reason, either audibly or visually, or both, explaining why the customer is not granted access. If the customer has arrived at the wrong location, time, or day, the ticket gate will provide audio/visual troubleshooting to help the customer.

In embodiments wherein the venue has employed a human to manage access to the event, the human will have an enterprise application on a mobile device that will allow them to visually authenticate access to the event with a simple interface that can interact with the centralized platform application or the blockchain directly. An access token owner will be able to authenticate by scanning a QR code, numerical code, barcode, or any other unique visual identifier readable by the customers device on the screen of the device the human employee is holding. If a customer scans the QR code, numerical code, barcode, or any other unique visual identifier readable by the customers device through the platform application, they have previously logged into and authenticated their token ownership with; the platform application will send an approval order to the enterprise application. The human employee will see a notification that directs them to either let the customer in or not or to retry the authentication process if a lost internet connection or other electronics malfunction happens. Suppose the customer scans the QR code, numerical code, barcode, or any other unique visual identifier readable by the customers device through their blockchain token wallet containing their access token. In that case, they will in-essence log into a decentralized application built into the enterprise application by approving a connection and then possibly signing a request to read the contents of that token wallet. Once the decentralized application has confirmed ownership of the access token, the human employee will see a notification that directs them to let the customer in. If the access token is not detected, the human employee will see a notification that directs to deny access to the event. If a connection issue occurs, the human employee will be directed to ask the customer to try the authentication process again. In a scenario where a customer has a valid access token to an event but is perhaps at the venue on the wrong day or time, or should be at a different location, the metadata included in the access token will inform the enterprise application to show the human employee a notification that will help them guide the customer to the correct event, time or location. The enterprise application provides the human employee with visual information that directs them to either: permit entry, deny entry, retry authentication, or troubleshoot.

In the following example, a venue employee will be using a mobile phone with a touch screen. The venue employee logs into the app on a device that can display a QR code and connect to the internet to use the enterprise application. The venue employee sees a large button in the center of the screen that says, “Generate QR code for attendee to scan.” The employee presses the button and a secure QR code is generated and shown on the screen. The attendee scans the QR code with their device camera. After the attendee's access token is approved, a notification approving access is shown on the screen alongside details of the event stored in the access token's metadata. The venue employee now knows where to guide the attendee. If the access token is not approved, a notification disapproving access is shown on the screen alongside details of why the access is not granted. The venue employee now knows why the attendee is not permitted access, such as the wrong date, venue, or time. Suppose there is a scan error for any reason. In that case, a scan error notification is generated, and the venue employee can press a button to initiate another authentication with a new QR code. The option for a venue employee to initiate another authentication with a new QR code is available on all screens. When the QR code is generated, the venue employee also has the option to cancel the authentication for whatever reason and will be returned to the main screen where they can initiate a new authentication. The option to cancel authentication is also possible while the backend still verifies access.

In many of the embodiments, distributors and venues/exhibitors can also incorporate various ancillary offerings into the hybrid physical screening and VOD access DRM-unlocking NFT, such as pre-ordering food, drinks, and confectionery from the physical event, as well as pre-ordering physical merchandise. In this case, a customer would gain access to a physical event, a digital VOD file, and a combination of food and drinks at the physical event all with one DRM-unlocking NFT. In order for the venue to serve the food and drinks to the customer, they would follow the same process as described before with QR codes, numerical codes, barcodes, or any other unique visual identifiers readable by the customers device or location data for authentication of NFT ownership and event access with a ticket gate or human employee using an enterprise application. If a customer pre-orders a burger, popcorn, and soft drink, that would be written into the metadata of their NFT, and the NFT would be verifiable at the venue by an employee or automated system.

In some of these embodiments, a customer would get access to a physical event, a digital VOD file, and a combination of food and drinks at the physical event all with one MOVIEKEY or other access token. In order for the venue to serve the food and drinks to the customer, they would follow the same process as described before with QR codes, numerical codes, barcodes, or any other unique visual identifiers readable by the customers device or location data authentication token ownership and event access with a ticket gate or human employee using an enterprise application. If a customer pre-orders a burger, popcorn, and soft drink, that would be written into the metadata of their token, and the token would be verifiable at the venue by an employee or automated system.

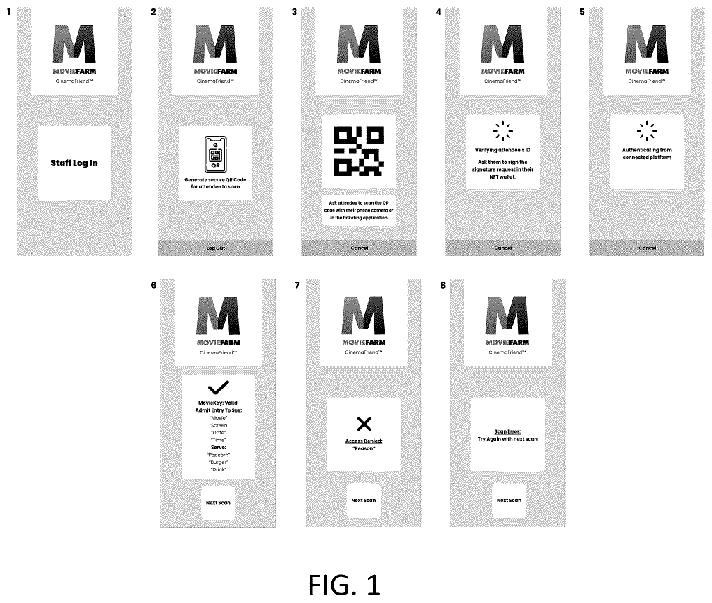

Turning now to the figures, FIG. 1 illustrates a CinemaFriend application in accordance with embodiments of the inventive subject matter. As shown in this figure X1, 1 shows a staff log in button, 2 shows a button for a staff member to press wherein pressing the button makes the app generate a secure QR code for the attendee to scan. Under the QR code button is a log-out button. 3 shows the QR code generated by the app for the attendee to scan. 4 shows a screening directing the staff member to ask the attendee to sign a signature request on their crypto wallet. 5 shows the app authenticating a connection from a connected platform. 6 shows a valid MOVIEKEY/access pass with details of the ticket and details of ancillary purchases such as food and drink. 7 shows access denied and a reason given; and 8 shows a scan error.

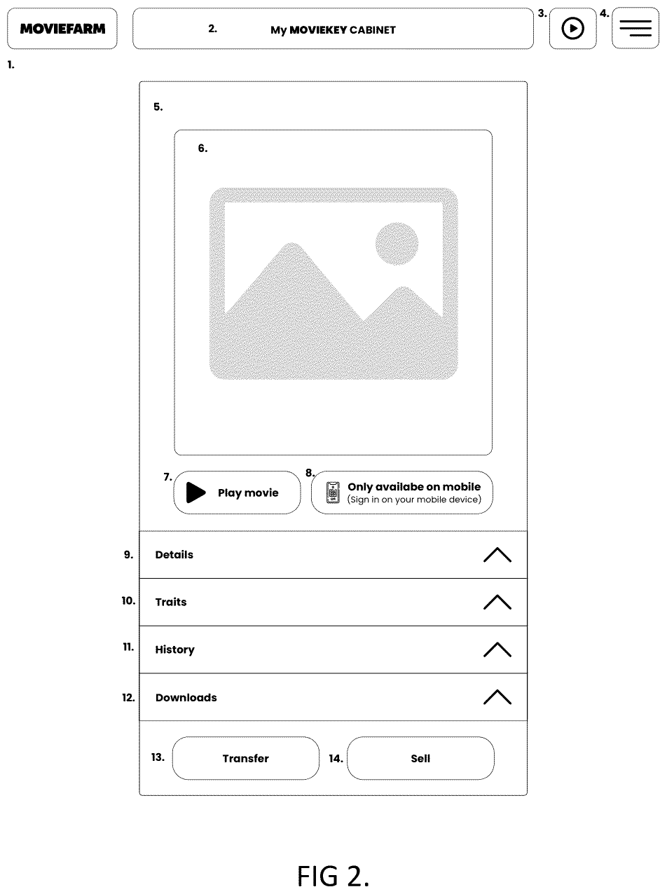

FIG. 2 illustrates a MOVIEKEY collection showing in the MOVIEKEY owner's digital movie cabinet according to embodiments of the inventive subject matter. Element 1 shows a logo on the app; 2 shows a current page; 3 Shows a button to access the MOVIEKEY cabinet; 4 shows an exemplary menu; 5 shows an individual MOVIEKEY NFT; 6 shows the artwork of that individual MOVIEKEY; 7 shows a button to play the video file; and 8 shows a button unavailable on a device without a camera. The button can be used to open the camera and scan a QR code at a venue on mobile, for example the user can scan a QR code generated on the CinemaFriend app. 9 shows a drop-down box that contains details such as a bio, creator details, and other pertinent information; 10 shows a drop-down box that visually displays the traits of the MOVIEKEY artwork and file; 11 shows a drop-down box that visually displays the trading history and provenance of the MOVIEKEY; 12 shows a drop-down box that contains downloadable files available to the owner of that individual MOVIEKEY; 13 shows a button that will allow the MOVIEKEY owner to transfer the MOVIEKEY to another blockchain wallet address; and 14 shows a button that will allow the MOVIEKEY owner to list the MOVIEKEY for sale on a marketplace.

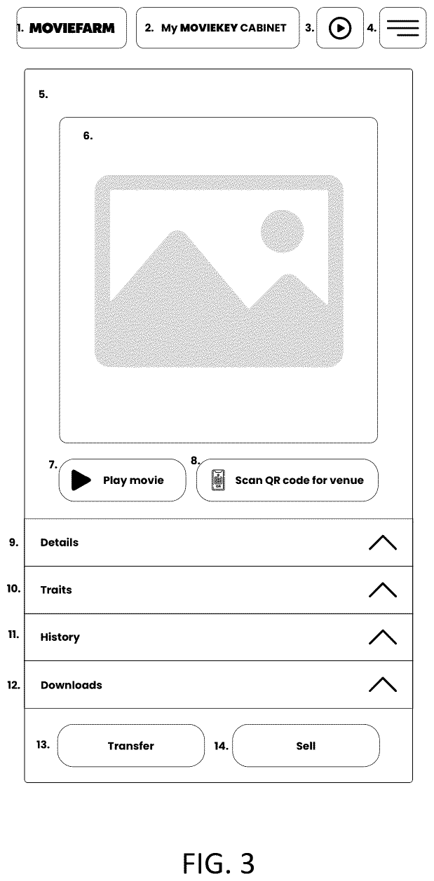

FIG. 3 illustrates a MOVIEKEY cabinet mobile application according to embodiments of the inventive subject matter. Element 1 shows a logo on the app; 2 shows a current page; 3 shows a button to access the MOVIEKEY cabinet; 4 shows a menu; 5 shows an individual MOVIEKEY NFT; 6 shows the artwork of a the individual MOVIEKEY; 7 shows a button to play the video file; and 8 shows a button to scan a QR code at a venue. For example, a user can scan a QR code generated on the CinemaFriend app. 9 shows a drop-down box that contains details such as a bio, creator details, and other pertinent information; 10 shows a drop-down box that visually displays the traits of the MOVIEKEY artwork and file; 11 shows a drop-down box that visually displays the trading history and provenance of the MOVIEKEY; 12 shows a drop-down box that contains downloadable files available to the owner of that individual MOVIEKEY; 13 shows a button that will allow the MOVIEKEY owner to transfer the MOVIEKEY to another blockchain wallet address; 14 shows a button that will allow the MOVIEKEY owner to list the MOVIEKEY for sale on a marketplace

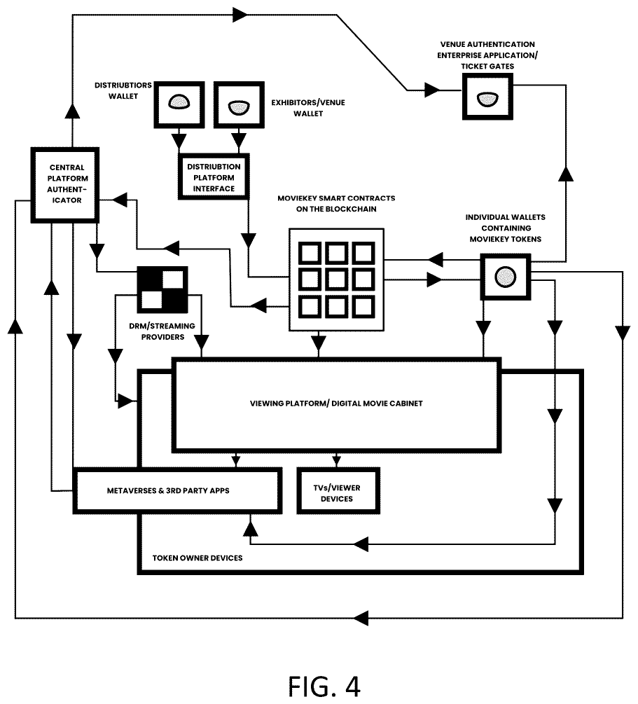

FIG. 4 illustrates an outline of a high level view of infrastructure processes according to embodiments of the inventive subject matter;

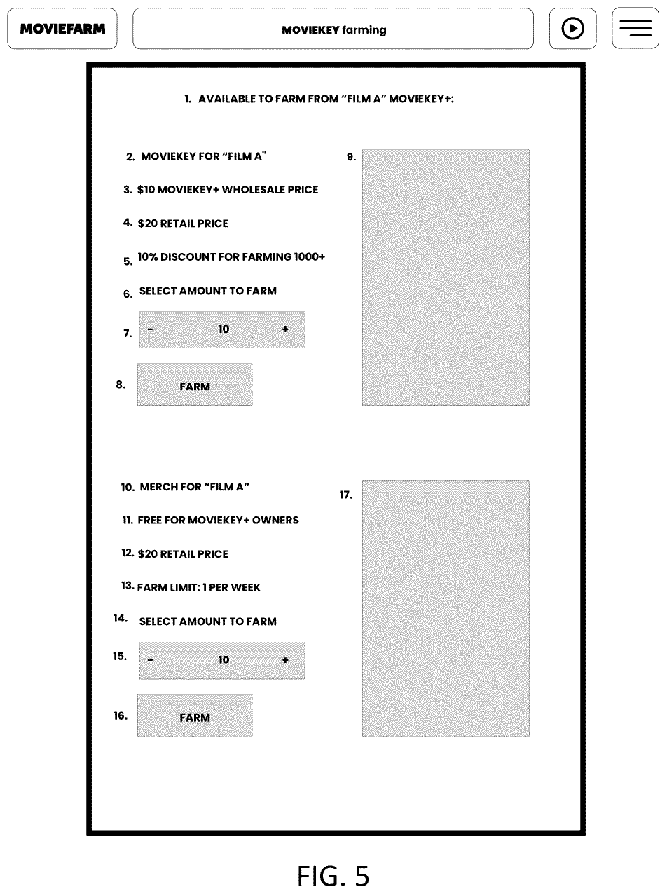

FIG. 5 illustrates a MOVIEKEY+ owner having the ability to farm standard MOVIEKEYs at a fixed price according to embodiments of the inventive subject matter. Element 1 shows a title of the page which in this exemplary embodiment are products available to farm for owners of the “FILM A” MOVIEKEY+NFT. 2 shows the title of the farmable product, in this instance, “FILM A” standard MOVIEKEY. 3 shows the cost to farm “FILM A” standard MOVIEKEY; 4 shows the minimum retail/secondary market price for “FILM A” MOVIEKEY that has been written into the smart contract by the distributor; 5 shows a discount for large-scale farming; 6 shows asking the farmer to select a number of “FILM A” MOVIEKEYs to farm; 7 shows the selector; and 8 shows the farm button in which pressing the button will initiate the transaction and begin farming after the farmer has paid the fees.

Also in this figure, 9 shows the poster for the farmable product in the section, in this instance, “FILM A” MOVIEKEY; 10 shows the title of the farmable product, in this instance, MERCH FOR “FILM A”; 11 shows the cost to farm MERCH FOR “FILM A”; 12 shows the minimum retail/secondary market price for MERCH FOR “FILM A” that has been written into the smart contract by the distributor; 13 Shows the daily, weekly, monthly, and yearly farm limit for the product; 14 shows asking the farmer to select a number of MERCH items FOR “FILM A” to farm; 15 shows the selector; and 16 Shows the farm button wherein pressing the button will initiate the transaction and begin farming after the farmer has paid the fees.

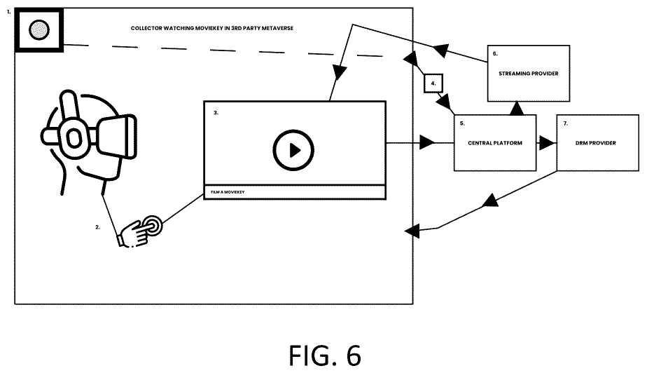

FIG. 6 illustrates a MOVIEKEY owner's device connected to a virtual world decentralized app via the MOVIEKEY owner's NFT wallet according to embodiments. 1 shows the MOVIEKEY owner's device connected to a virtual world decentralized app via the MOVIEKEY owner's NFT wallet; 2 shows the MOVIEKEY owner using VR apparatus to interact with a 3D/virtual MOVIEKEY cabinet to select content to view; 3 shows the MOVIEKEY file playing; 4 shows the API routing information and orders between the third party application and the central platform; 5 shows the central platform calling the DRM provider to send a DRM license to the MOVIEKEY collectors device so the collector can playback their desired MOVIEKEY content; 6 shows the streaming provider receiving an order from the central platform to send an encrypted stream of video data to the MOVIEKEY owner's device. The streaming provider sends the data, which is then decrypted by the authorized device and player. 7 represents the DRM provider receiving an order for the central platform and sending a DRM license to the MOVIEKEY collectors device.

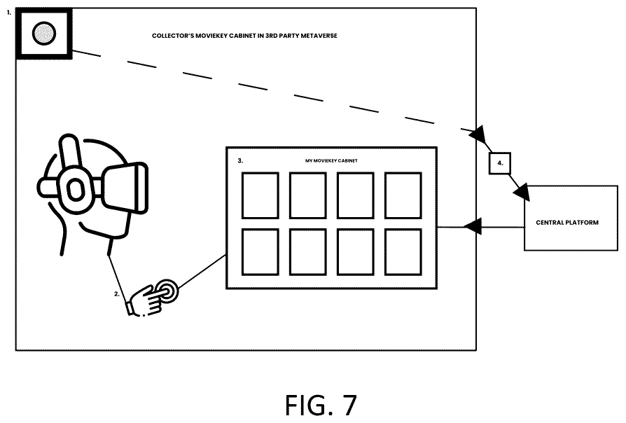

FIG. 7 illustrates a MOVIEKEY owner's device connected to a virtual world decentralized app via the MOVIEKEY owner's NFT wallet according to embodiments of the inventive subject matter. 1 shows a MOVIEKEY owner's device connected to a virtual world decentralized app via the MOVIEKEY owner's NFT wallet; 2 shows the MOVIEKEY owner using VR apparatus to interact with a 3D/virtual MOVIEKEY cabinet to select content to view; 3 shows the MOVIEKEY cabinet; 4 shows the API routing information and orders between the third party application and the central platform; and 5 represents the central platform routing information to the MOVIEKEY cabinet.

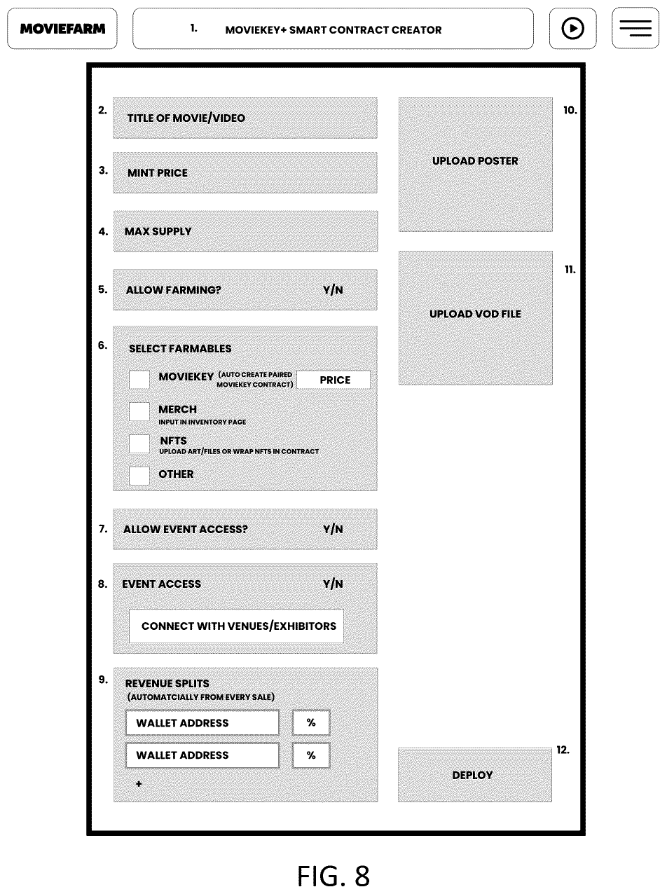

FIG. 8 illustrates a MOVIEKEY smart contract creator according to embodiments of the inventive subject matter. 1 shows title of page; 2 shows input field for title of video; 3 shows input field for mint price for MOVIEKEY+; 4 shows input field for max supply; 5 shows input field for allowing farming of standard MOVIEKEYs from a MOVIEKEY+; and 6 shows tick boxes fields for selecting farmables and input field for the price of a standard MOVIEKEY. Selecting MOVIEKEY will also create a standard MOVIEKEY contract as well as a MOVIEKEY+ contract. 7 shows option to allow event access with the contract's MOVIEKEY; and 8 shows the enablement of a connection request to be sent to a venue or exhibitor to join as co-author or signatory of business-relevant parameters of the smart contract. 9 shows revenue split input fields, crypto wallet address input fields, and relevant percentage split data input fields as well as a plus button to create infinite revenue splits; 10 shows field to upload poster or unique artwork files and JSON data files to name contract tokens with; 11 shows a field to upload a VOD file that the MOVIEKEY and MOVIEKEY+ will collectors give access to.

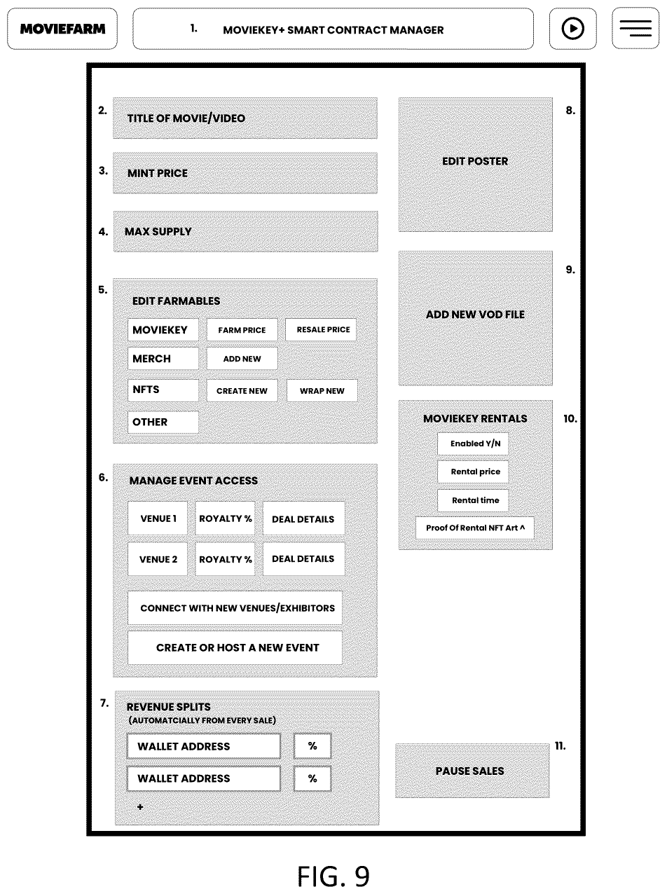

FIG. 9 illustrates a MOVIEKEY smart contract manager according to embodiments of the inventive subject matter. In the figure, 1 shows title of page; 2 shows input field for title of video; 3 shows input field for mint price for MOVIEKEY+; 4 shows input field for max supply; 5 shows input fields to edit farming rules of standard MOVIEKEYs, merch, and other NFTs from a MOVIEKEY+; 6 shows fields to manage event access, royalty splits with venues, and deal details (i.e contracts between venues and distributors); 7 shows revenue split input fields, crypto wallet address input fields, and relevant percentage split data input fields as well as a plus button to create infinite revenue splits; 8 shows field to edit poster or unique artwork files and JSON data files to name contract tokens with; 9 shows field to add a new VOD file; 10 shows a field manage MOVIEKEY rental rules; and 11 shows a button to pause sales.

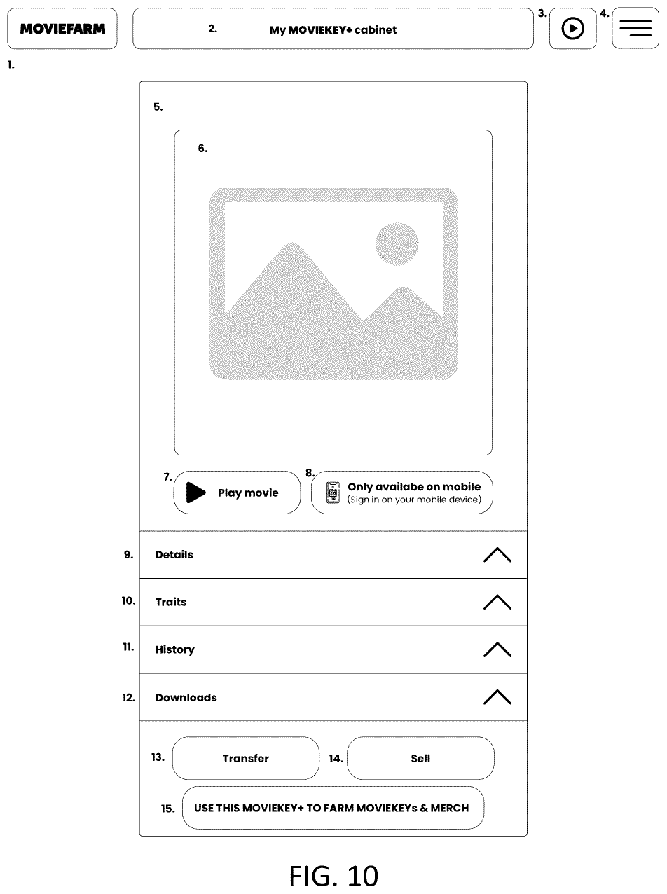

FIG. 10 illustrates a MOVIEKEY+ cabinet desktop according to embodiments of the inventive subject matter. As shown in the figure, element 1 shows a logo on the app; 2 shows the current page; 3 shows a button to access the MOVIEKEY cabinet; 4 shows an exemplary menu; 5 shows an individual MOVIEKEY NFT; 6 shows the artwork of that individual MOVIEKEY; 7 shows a button to play the video file; and 8 shows a button unavailable on a device without a camera. The button will open the camera and scan a QR code at a venue on mobile. for example when a user scans a QR code generated on the CinemaFriend app. 9 shows a drop-down box that contains details such as a bio, creator details, and other pertinent information; 10 shows a drop-down box that visually displays the traits of the MOVIEKEY artwork and file; 11 shows a drop-down box that visually displays the trading history and provenance of the MOVIEKEY; 12 shows a drop-down box that contains downloadable files available to the owner of that individual MOVIEKEY; 13 shows a button that will allow the MOVIEKEY owner to transfer the MOVIEKEY to another blockchain wallet address; 14 shows a button that will allow the MOVIEKEY owner to list the MOVIEKEY for sale on a marketplace; and 15 shows a button that will lead to the MOVIEKEY FARMING page and enable MOVIEKEY+ owners to farm standard MOVIEKEYs and merch available to their MOVIEKEY+.

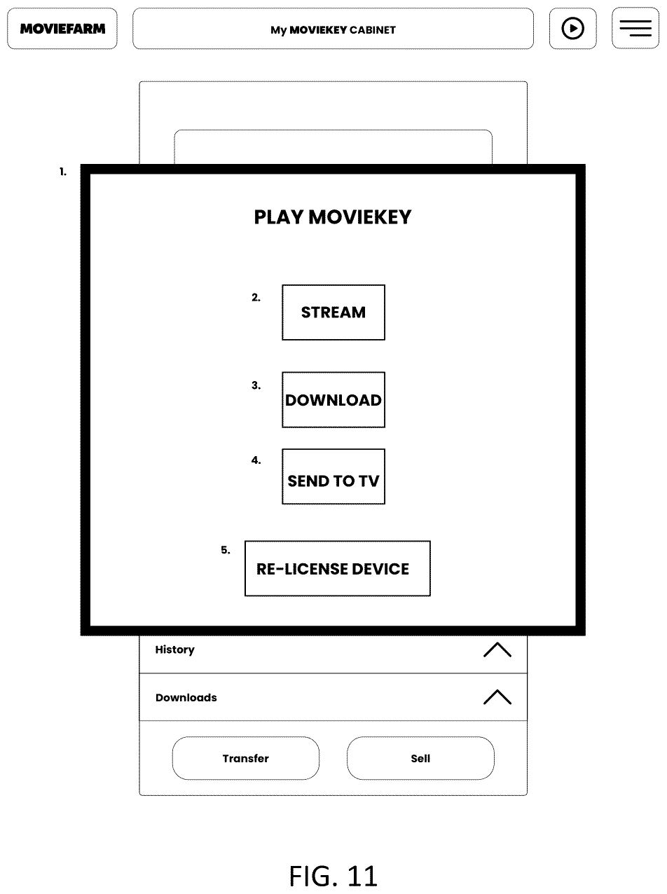

FIG. 11 illustrates a MOVIEKEY play chart according to embodiments of the inventive subject matter. In the figure, element 1 shows the player controller popup; 2 shows button to stream on the current device; 3 shows button to download the encrypted VOD file to the hard drive of the device; 4 shows a button to send the VOD file to a TV; and 5 shows a button to re-license the current device with DRM.

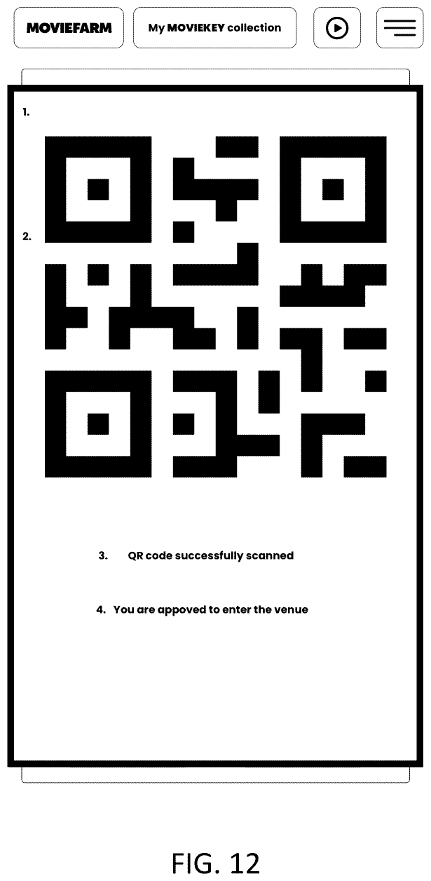

FIG. 12 illustrates a QR code interaction for CinemaFriend application according to embodiments of the inventive subject matter. In the figure, 1 shows the open camera on a camera-enabled device logged into the platform scanning an external QR code; 2 shows the QR code; 3 shows the response from the app; and 4 shows the response from the database authorizing the MOVIEKEY/access token collector's request.

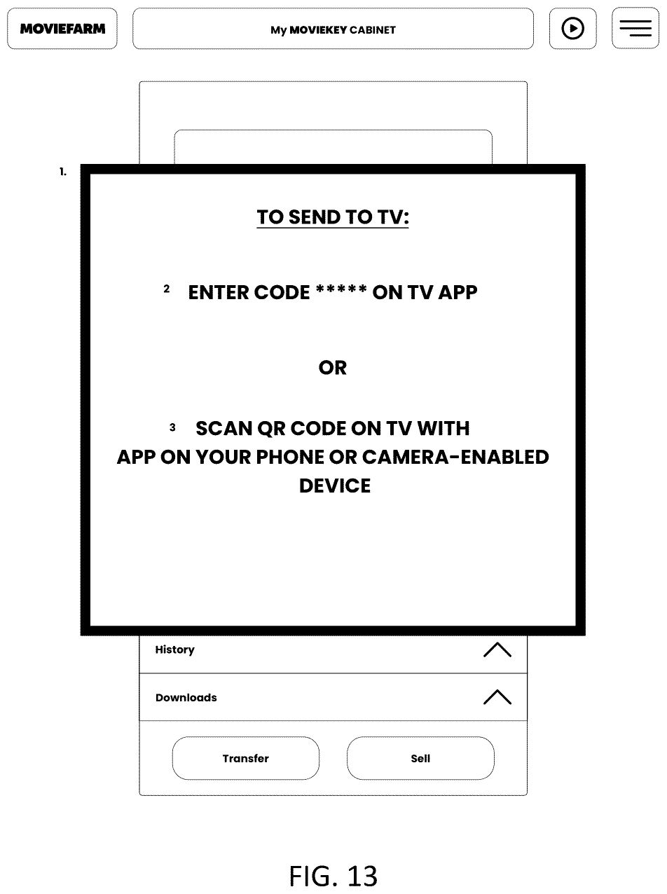

FIG. 13 illustrates a SEND TO TV application according to embodiments of the inventive subject matter. In this figure, 1 shows the popup over MOVIEKEY after the collector has requested to send the VOD file to the TV; 2 shows an option to enter securely generated code on TV to authorize TV; 3 shows a button to open the camera and scan of QR code displayed on the TV with the collector's camera-enabled device. For example, scanning the QR will authorize the TV and send the MOVIEKEY VOD file to the TV. In these embodiments, playback controls will be available with the TV remote and the platform app.

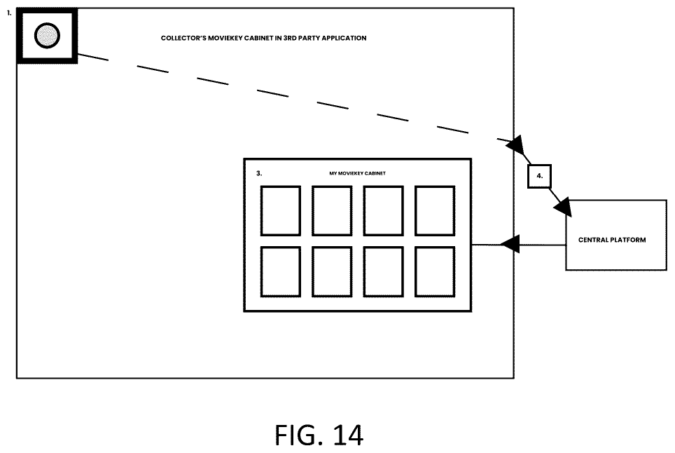

FIG. 14 illustrates a MOVIEKEY application as used with a third party application according to embodiments of the inventive subject matter. Element 1 shows a collectors wallet connected to a third party application; 3 shows a MOVIEKEY cabinet; 4 shows the API routing information and orders between the third party application and the central platform; and 5 represents the central platform routing information to the MOVIEKEY cabinet.

Many embodiments include a “remind me later” feature that enables customers to be reminded to watch, purchase, or rent content at a later date. Users can choose to receive reminders through various communication channels, such as email, text message, phone call, or social media direct message. This feature allows users to easily keep track of their desired content and helps drive engagement and sales.

Additionally, many of the embodiments also include distribution analytics that enable distributors to gain insights into the performance of their content. Distributors can access metrics such as the total number of views, sales, rentals, and “remind me later” requests for each piece of content. This valuable data can help distributors make informed decisions about their content strategy, marketing efforts, and pricing models.

One of ordinary skill in the art knows that the use cases, structures, schematics, and flow diagrams may be performed in other orders or combinations, but the inventive concept of the present disclosure remains without departing from the broader scope of the inventive subject matter. Every embodiment may be unique, and methods/steps may be either shortened or lengthened, overlapped with the other activities, postponed, delayed, and continued after a time gap, such that every end-user device is accommodated by the server to practice the systems and methods of the inventive subject matter.

The present inventive subject matter may be implemented in hardware and/or in software. Many components of the system, for example, signal processing modules or network interfaces, as non-limiting examples, have not been shown, so as not to interfere with embodiments of the present inventive subject matter. However, one of ordinary skill in the art would appreciate that the system may include one or more of these components. A computing device is a hardware that includes at least one processor coupled to a memory. The processor may represent one or more processors (e.g., microprocessors), and the memory may represent random access memory (RAM) devices comprising a main storage of the hardware, as well as any supplemental levels of memory, e.g., cache memories, non-volatile or back-up memories (e.g., programmable or flash memories), read-only memories, etc. In addition, the memory may be considered to include memory storage physically located elsewhere in the hardware, e.g. any cache memory in the processor, as well as any storage capacity used as a virtual memory, e.g., as stored on a mass storage device.

The hardware of a computing device also typically receives a number of inputs and outputs for communicating information externally. For interface with a user, the hardware may include one or more user input devices (e.g., a keyboard, a mouse, a scanner, a microphone, a camera, etc.) and a display (e.g., a Liquid Crystal Display (LCD) panel). For additional storage, the hardware may also include one or more mass storage devices, e.g., a floppy or other removable disk drive, a hard disk drive, a Direct Access Storage Device (DASD), an optical drive (e.g., a Compact Disk (CD) drive, a Digital Versatile Disk (DVD) drive, etc.) and/or a tape drive, among others. Furthermore, the hardware may include an interface to one or more networks (e.g., a local area network (LAN), a wide area network (WAN), a wireless network, and/or the Internet among others) to permit the communication of streaming content and information with other computers coupled to the networks. It should be appreciated that the hardware typically includes suitable analog and/or digital interfaces to communicate with each other.

In some embodiments of the inventive subject matter, the entire system can be implemented and offered to the end-users and operators over a private network or a public network such as the Internet, in a so-called cloud implementation, or any combination of the two. No local installation of software or hardware may be needed in many embodiments, and the end-users and operators could be allowed access to the systems of the embodiments directly over the Internet, using either a web browser or similar software on a client, which client could be a desktop, laptop, mobile device, and the like. This can eliminate the need for custom software installation on the client side and increases the flexibility of delivery of the service (software-as-a-service) and increases user satisfaction and ease of use. Various business models, revenue models, and various delivery mechanisms for the present inventive subject matter are to be considered within the scope of the present claimed subject matter.

In many embodiments, the hardware operates under the control of an operating system, and executes various computer software applications, components, program code, libraries, objects, modules, etc. to perform the methods, processes, and techniques described above.

In general, the method executed to implement the embodiments of the inventive subject matter may be implemented as part of an operating system or a specific application, component, program, object, module or sequence of instructions referred to as “computer program(s)” or “program code(s).” The computer program or programs typically comprise one or more instructions set at various times in various memory and storage devices in one or more computing devices or computers, and that, when read and executed by one or more processors in the computer, cause the computer or computers to perform operations necessary to execute elements involving the various aspects of the inventive subject matter. While the inventive subject matter has been described in the context of fully functioning computers and computer systems, those skilled in the art will appreciate that the various embodiments of the inventive subject matter are capable of being distributed as a program product in a variety of forms, and that the described embodiments of the inventive subject matter apply equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD-ROMS), Digital Versatile Disks, (DVDs), etc.), and digital and analog communication media.

Although specific embodiments of the inventive subject matter have been described, one of ordinary skill in the art will recognize that numerous other modifications and alternative embodiments are within the scope of this disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure and the claimed subject matter.

Blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and/or computer instructions.

A software component or element may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or any specific platform.

A software component may be stored as a file or other data storage construct. Software components of a similar type or functionally related may be stored together such as, for example, in a particular directory, folder, or library. Software components may be static (for example, pre-established or fixed) or dynamic (for example, created or modified at the time of execution).

Software components may invoke or be invoked by other software components through any of a wide variety of mechanisms. Invoked or invoking software components may comprise other custom-developed application software, operating system functionality (for example, device drivers, data storage (for example, file management) routines, other common routines and services, etc.), or third-party software components (for example, middleware, encryption, or other security software, database management software, file transfer or other network communication software, mathematical or statistical software, image processing software, and format translation software). Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Although embodiments have been described in language specific to structural features and/or methodological acts, it is to be understood that this disclosure is not necessarily limited to the specific features or acts described. Rather, the specific features and acts are disclosed as illustrative forms of implementing the embodiments of the inventive subject matter. Conditional language, such as, among others, “can,” “could,” “might,” or “may,” unless specifically stated otherwise, or otherwise understood within the context as used, is generally intended to convey that many of the embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Although the present inventive subject matter has been described with reference to specific exemplary embodiments, it will be evident that the various modification and changes can be made to these embodiments without departing from the broader scope of the inventive subject matter. Accordingly, the specification and drawings are to be regarded in an illustrative sense rather than in a restrictive sense. It will also be apparent to the skilled artisan that the embodiments described above are specific examples of a single broader inventive concept which may have greater scope than any of the singular descriptions taught. There may be many alterations made in the descriptions without departing from the scope of the present claimed subject matter.

What is claimed is:

1. A system for creating and distributing DRM-unlocking non-fungible tokens (NFTs) associated with DRM-encrypted video content for allowing users to purchase and own access to the content, comprising:
a. a DRM-unlocking NFT platform for playing encrypted content;
b. an interface for allowing one or more distributors to deploy one or more DRM-unlocking NFT smart contracts and set one or more DRM-unlocking NFT price and parameters related to the encrypted content including one or more of the following parameters: availability, launch date, rental conditions, NFT farming access, physical event access, and rewards;
c. a server configured to store encrypted content and associate it with one or more DRM-unlocking NFT smart contracts and one or more NFTs;
d. a platform database that stores the encrypted content and parameters about the one or more DRM-unlocking NFTs, including one or more of the following parameters: metadata with a unique identifier, artwork, and a video player link;
e. a payment system that provides instant payment to one or more distributors' wallet addresses via a blockchain when one or more DRM-unlocking NFTs are purchased;
f. a verification system that connects a user's wallet to the DRM-unlocking NFT platform for verifying the user's ownership of the DRM-unlocking NFT associated with the encrypted content; and
g. a delivery system that grants a DRM-unlocking NFT owner access to the encrypted content by sending one or more DRM licenses to the DRM-unlocking NFT owner's device along with the encrypted content so that the DRM-unlocking NFT owner can play the decrypted content on the DRM-unlocking NFT platform or on one or more third-party platforms that request and receive the DRM license information from the DRM-unlocking NFT platform.

2. The system of claim 1, further comprising a feature allowing the one or more distributors to send one or more payments to one or more blockchain wallet addresses.

3. The system of claim 1, further comprising a rental manager that enables one or more DRM-unlocking NFT owners to rent the encrypted content associated with the one or more DRM-unlocking NFTs content to others according to the one or more predetermined parameters.

4. The system of claim 1, wherein distributors and physical exhibitors can create one or more hybrid DRM-unlocking NFTs that allow access to both physical events and encrypted content.

5. The system of claim 4, wherein the one or more hybrid DRM-unlocking NFTs includes metadata having information on the physical event location, the time of the physical event, the seat selection for the physical event, and the distributor's agreement with the exhibitor for access to the encrypted content.

6. The system of claim 4, further comprising an authenticator authenticating the ownership of the one or more hybrid DRM-unlocking NFTs for allowing access to the physical event access by scanning a QR code, sharing their location with the ticket gate, or logging into a decentralized application.

7. The system of claim 1, further comprising one or more application players for DRM-unlocking NFT owners to access and play DRM-encrypted content in any application player that has implemented the related SDK and API, wherein the application player enables DRM-unlocking NFT owners to:
a. select the DRM-unlocking NFT associated with the desired content; and
b. play the encrypted content within the one or more application players having the SDK and API integrated with the application player.

8. The system of claim 1, further comprising a system allowing DRM-unlocking NFT owners to transfer, sell, or trade DRM-unlocking NFTs on the DRM-unlocking NFT platform or one or more third-party marketplaces.

9. The system of claim 1, further comprising a virtual gallery for enabling DRM-unlocking NFT owners to showcase their DRM-unlocking NFT collection and encrypted content in a virtual gallery.

10. The system of claim 1, further comprising a sharing module for enabling one or more DRM-unlocking NFT owners to provide limited access to the encrypted content with one or more third party users based on one or more parameters by providing:
a. a selection mechanism for the DRM-unlocking NFT associated with the encrypted video content to be shared;
b. a sharing interface;
c. one or more adjustable sharing parameters selected from one or more of the following: duration of access and one or more access limitations;
d. a unique sharing link or a code for the selected encrypted content; and
e. a communication mechanism for sending the sharing link or code to one of more third party users, allowing one or more of those users to access the encrypted content within the specified parameters.

11. The system of claim 1, further comprising a farming module configured to allow distributors to offer NFT farming access as part of the DRM-unlocking NFT parameters, by:
a. creating a farming-enabled DRM-unlocking NFT represented by a smart contract;
b. setting one or more farming parameters from which the farming-enabled DRM-unlocking NFTs can be farmed; and
c. enabling one or more DRM-unlocking NFT owners to farm one or more farming-enabled DRM-unlocking NFTs.

12. The system of claim 1, further comprising a reward module configured to allow distributors to offer rewards as part of the DRM-unlocking NFT parameters, by:
a. creating a reward-enabled DRM-unlocking NFT represented by a smart contract;
b. setting the one or more reward parameters selected from one or more of the following: one or more reward amounts and one or more eligibility criteria; and
c. enabling DRM-unlocking NFT owners to access and claim one or more rewards according to the one or more reward parameters.

13. The system of claim 1, further comprising a SDK and an API provider module configured to enable the encrypted content to be playable in any application that has implemented the SDK and the API, by:
a. allowing developers to integrate the platform's DRM-unlocking NFT functionality within one or more third party applications;
b. providing a set of tools and documentation for developers to customize the user interface and user experience within the one or more third party applications;
c. facilitating the secure exchange of data between the DRM-unlocking NFT platform and the one or more third party applications, ensuring the DRM-unlocking NFT ownership verification and DRM license delivery processes are verified;
d. enabling developers to access and display DRM-unlocking NFT metadata within the one or more third party applications, allowing users to view information about the video content, such as title, description, artwork, and unique identifier; and
e. enabling developers to add a play button to the one or more third party applications allowing users to play the encrypted video content within the one or more third party applications.

14. The system of claim 1, further comprising a content access module configured to enable one or more DRM-unlocking NFT owners to access one or more additional features and/or encrypted content within the DRM-unlocking NFT platform, based on the one or more predetermined parameters by:
a. verifying ownership of the DRM-unlocking NFT and checking the one or more predetermined parameters; and
b. granting access to the one or more features or content within the platform, such as exclusive behind-the-scenes footage, director's commentary, or bonus materials, based on the one or more predetermined parameters.

15. The system of claim 1, wherein the encrypted content is one or more encrypted videos.

16. The system of claim 1, further comprising a remind me later module feature configured to enable one or more users to set reminders to watch, purchase, or rent content at a later date through various communication channels, including email, text message, phone call, or social media direct message.

17. The system of claim 1, further comprising a distribution analytics module configured to provide one or more distributors with insights into the performance of their content, by tracking and reporting metrics such as total views, sales, rentals, and “remind me later” requests for each piece of content.

18. A system for creating, distributing DRM-unlocking non-fungible tokens (NFTs) associated with DRM-encrypted video content and allowing users to purchase and own access to the DRM-encrypted video content, comprising:
a. a DRM-unlocking NFT platform serving as a central platform for playing content;
b. an interface that allows distributors to deploy one or more DRM-unlocking NFT smart contracts, an associated DRM-unlocking NFT price, and one or more parameters selected from the following: availability, launch date, rental conditions, NFT farming access, physical event access, and rewards;
c. a server configured to store encrypted video content and associate it with the one or more DRM-unlocking NFT smart contracts and one or more NFTs;
d. a platform database that stores the encrypted video content and information about the DRM-unlocking NFT, including one or more of the following: metadata with a unique identifier, artwork, and a video player link;
e. a payment system that provides payment to one or more wallet addresses via blockchain when one or more DRM-unlocking NFTs are purchased;
f. a verification system for linking the one or more wallet addressed to the DRM-unlocking NFT platform and for verifying ownership of the DRM-unlocking NFT linked to the encrypted video content;
g. a delivery system for granting the DRM-unlocking NFT owner access to the encrypted video content by sending a DRM license and the encrypted video file to the DRM-unlocking NFT owner's device so that the decrypted video can be played on the central platform or one or more third-party platforms that calls the central platform to send the DRM license;
h. a management system for allowing payments to be sent when a DRM-unlocking NFT is purchased; and
i. a partnership management system for allowing one or more distributors and one or more exhibitors the ability to co-create hybrid DRM-unlocking NFT smart contracts that mint one or more NFTs capable of allowing owners entry to physical events and downloading and decrypting the DRM-encrypted VOD files associated with the DRM-unlocking NFT smart contract and its associated one or more NFTs.

19. A method for creating and distributing DRM-unlocking non-fungible tokens (NFTs) associated with DRM-encrypted video content, allowing users to purchase and own access to the DRM-encrypted video content, comprising the steps of:
a. generating a DRM-unlocking NFT smart contract using a DRM-unlocking NFT platform;
b. uploading the DRM-encrypted video to a server and associating it with the DRM-unlocking NFT smart contract in a DRM-unlocking NFT platform database;
c. offering an interface for distributors to set DRM-unlocking NFT price and one or more parameters selected from the following: availability, launch date, rental conditions, NFT farming access, physical event access, and rewards;
d. adding metadata to the DRM-unlocking NFT selected from one or more of the following: a unique identifier, artwork, and a video player link;
e. making the DRM-unlocking NFT available for users to purchase;
f. providing instant payment to one or more distributors' wallet addresses via a blockchain when one or more DRM-unlocking NFTs are purchased;
g. verifying a user's ownership of the DRM-unlocking NFT linked to the encrypted video content by connecting the user's wallet to the platform; and
h. granting access to the encrypted video content by sending a DRM license to the user's device after verifying the user's DRM-unlocking NFT ownership.

20. The method of claim 19, further comprising the steps of:
a. providing a DRM-unlocking NFT platform for one or more distributors and/or physical exhibitors to collaborate and create a hybrid DRM-unlocking NFT;
b. creating the hybrid DRM-unlocking NFT with metadata including one or more of the following attributes: a physical event location, a time, seat selection, and the distributor's agreement with the exhibitor for digital VOD file access; and
c. authenticating the ownership of the hybrid DRM-unlocking NFT for physical event access by doing one or more of the following: verifying a code, sharing their location with the ticket gate, or logging into a decentralized application;
wherein distributors and physical exhibitors can utilize one or more hybrid DRM-unlocking NFTs for providing access to physical events and video-on-demand (VOD) content.

21. The method of claim 19, further comprising a method for enabling DRM-unlocking NFT owners to access additional features or content within the platform, based on the one or more parameters, the steps including:
a. verifying the user's ownership of the DRM-unlocking NFT and checking the one or more parameters of the DRM-unlocking NFT; and
b. granting access to one or more features or encrypted content within the DRM-unlocking NFT platform with the one or more features selected from the following: exclusive behind-the-scenes footage and director's commentary.

22. The method of claim 19, further comprising steps for enabling DRM-unlocking NFT owners to showcase their DRM-unlocking NFT collection and video content in a virtual gallery, the steps including:
a. accessing the virtual gallery feature within the platform;
b. selecting the DRM-unlocking NFTs and associated video content to be displayed;
c. customizing the virtual gallery's layout, design, and user experience; and
d. sharing the virtual gallery with other users or embedding it on one or more external websites or platforms.

23. The method of claim 19, further comprising steps for allowing distributors to offer NFT farming access as part of the DRM-unlocking NFT parameters, the steps including:
a. creating a farming-enabled DRM-unlocking NFT represented by a smart contract;
b. setting the farming parameters from one or more of the following: a collection from which the DRM-unlocking NFTs can be farmed and a farming rate; and
c. enabling one or more DRM-unlocking NFT owners to farm new DRM-unlocking NFTs according to the farming parameters.
